(19) United States
(12) Patent Application Publication
(10) Pub. No.: US 2018/0034595 A1
(43) Pub. Date: Feb. 1, 2018

(54) METHOD FOR TRANSMITTING AND RECEIVING POLICY INDICATOR-BASED ACKNOWLEDGEMENT/NON-ACKNOWLEDGEMENT SIGNAL IN WIRELESS LAN SYSTEM, AND DEVICE THEREFOR

(71) Applicant: LG Electronics Inc., Seoul (KR)

(72) Inventors: Jeongki Kim, Seoul (KR); Kiseon Ryu, Seoul (KR); Hangyu Cho, Seoul (KR)

(21) Appl. No.: 15/548,698

(22) PCT Filed: Jan. 29, 2016
(86) PCT No.: PCT/KR2016/001005

§ 371 Date: Aug. 3, 2017

Related U.S. Application Data
(60) Provisional application No. 62/111,117, filed on Feb. 3, 2015.
(60) Provisional application No. 62/113,530, filed on Feb. 9, 2015.

(51) Int. Cl. H04L 1/16; H04L 1/18; H04L 5/00

(52) U.S. Cl. CPC H04L 1/1671; H04L 5/0055; H04L 1/1854; H04W 72/042

(57) ABSTRACT

According to the present invention an AP transmits a trigger frame to a plurality of stations (STAs), and transmits an ACK/NACK signal for data received from the plurality of STAs when the data is received from the plurality of STAs in response to the trigger frame. At this time, an ACK policy value having a specific value is set in one or more STAs among the plurality of STAs, the AP transmits, through a multi-user block ACK (M-BA) frame, an ACK/NACK signal for STAs excluding the one or more STAs among the plurality of STAs, and the ACK/NACK signal for the one or more STAs is transmitted in response to a block ACK request message received from the one or more STAs.

### TECHNICAL FIELD

The following description relates to a method of transmitting and receiving an acknowledgement/negative-acknowledgement signal for multiple users or multiple stations (STAs) on the basis of an ACK policy in a wireless LAN system, and a device therefor.

### BACKGROUND ART

Standards for a Wireless Local Area Network (WLAN) technology have been developed as Institute of Electrical and Electronics Engineers (IEEE) 802.11 standards. IEEE 802.11a and b use an unlicensed band at 2.4 GHz or 5 GHz. IEEE 802.11b provides a transmission rate of 11 Mbps and IEEE 802.11a provides a transmission rate of 54 Mbps. IEEE 802.11g provides a transmission rate of 54 Mbps by applying Orthogonal Frequency Division Multiplexing (OFDM) at 2.4 GHz. IEEE 802.11n provides a transmission rate of 300 Mbps for four spatial streams by applying Multiple Input Multiple Output (MIMO)-OFDM. IEEE 802.11n supports a channel bandwidth of up to 40 MHz and, in this case, provides a transmission rate of 600 Mbps.

The above-described WLAN standards have evolved into IEEE 802.11ac that uses a bandwidth of up to 160 MHz and supports a transmission rate of up to 1 Gbits/s for 8 spatial streams and IEEE 802.11ax standards are under discussion.

### DISCLOSURE

### Technical Problem

In the IEEE 802.11ax standards, an Uplink (UL) Orthogonal Frequency Division Multiple Access (OFDMA) transmission scheme and a UL Multi-User (MU) transmission scheme will be used. Then, an Access Point (AP) may receive UL MU frames from a plurality of STAs at the same transmission opportunity and needs to transmit an Acknowledgement (ACK) frame in response to the UL MU frames.

In this case, efficient transmission of an ACK signal to a plurality of STAs through a Block ACK (BA) frame may be considered. However, overhead may be problematic due to an increased size of an MU BA frame for a plurality of STAs.

A description will be given of a method for efficiently transmitting an acknowledgement/negative-acknowledgement signal in the aforementioned UL MU transmission situation and a device therefor.

### Technical Solution

To accomplish the aforementioned object, one aspect of the present invention proposes a method by which an access point (AP) transmits acknowledgement/negative-acknowledgement (ACK/NACK) signals for data transmitted from a plurality of stations (STAs) in a wireless LAN (WLAN) system, including: transmitting a trigger frame to the plurality of STAs; receiving data from the plurality of STAs in response to the trigger frame, at least one STA among the plurality of STAs having an ACK policy value set to a specific value; and transmitting ACK/NACK signals for the data received from the plurality of STAs, wherein ACK/NACK signals for STAs other than the at least one STA among the plurality of STAs are transmitted through a multi-user block ACK (M-BA) frame, and an ACK/NACK signal for the at least one STA is transmitted in response to a block ACK request message received from the at least one STA.

Specifically, the ACK/NACK signal for the at least one STA may be transmitted when the block ACK request message transmitted in a contention-based method from the at least one STA is received after the M-BA frame is transmitted. The ACK/NACK signal for the at least one STA may be transmitted when the block ACK request message transmitted from the at least one STA on the basis of an SIFS is received after the M-BA frame is transmitted.

The ACK policy value set to the specific value for the at least one STA may be set through data received from the at least one STA.

The ACK policy value set to the specific value for the at least one STA may be set by the AP and transmitted to the at least one STA through the trigger frame.

An additional trigger frame may be transmitted to the at least one STA such that the at least one STA transmits a multi-user block ACK request message.

Here, when the multi-user block ACK request message is received, the ACK/NACK signal for the at least one STA may be transmitted through an additional M-BA frame.

The additional M-BA frame may not include start sequence information and a block ACK bitmap when all data units are successfully received from the at least one STA.

When a specific data unit and the following data units from among data received from the at least one STA are successfully received, the additional M-BA frame may include start sequence information corresponding to the specific data unit without a block ACK bitmap.

The trigger frame may include resource allocation information for transmission of the multi-user block ACK request message.

The ACK policy value may be set to one of a first value indicating an implicit block ACK request, a second value for requesting no ACK/NACK for transmitted data, a third value for requesting only an ACK/NACK signal of a specific mode and a fourth value for requesting block ACK request message based ACK/NACK signal transmission, and the ACK policy value set to the specific value may have the fourth value. STAs other than the at least one STA from among the plurality of STAs may have ACK policy values set to the first value.

In another aspect, the present invention proposes a method by which an STA receives an ACK/NACK signal for transmitted data from an AP in a WLAN system including: receiving a trigger frame from the AP; transmitting data to the AP through a multi-user frame in response to the trigger frame, an ACK policy value for the STA being set to a specific value; receiving the ACK/NACK signal for the transmitted data through an M-BA frame when the specific value is a first value; and transmitting a block ACK request message to the AP and receiving an ACK/NACK signal when the specific value is a fourth value.

In another aspect, the present invention proposes an AP apparatus for transmitting ACK/NACK signals for data transmitted from a plurality of STAs in a WLAN system, including: a transceiver configured to transmit a trigger frame to the plurality of STAs, to receive data from the plurality of STAs in response to the trigger frame and to transmit ACK/NACK signals for the data received from the plurality of STAs; and a processor connected to the transceiver and configured to process the trigger frame, the received data and the ACK/NACK signals, wherein the processor controls the transceiver to transmit ACK/NACK signals for STAs other than at least one STA having an ACK policy value set to a specific value from among the plurality of STAs through an M-BA frame and to transmit an ACK/NACK signal for the at least one STA in response to a block ACK request message received from the at least one STA.

In another aspect, the present invention proposes a station apparatus operating as an STA for receiving an ACK/NACK signal for transmitted data from an AP in a WLAN system, including: a transceiver configured to receive a trigger frame transmitted to a plurality of STAs including the STA, to transmit data to the AP in response to the trigger frame and to receive an ACK/NACK signal for the data from the AP; and a processor connected to the transceiver and configured to process the trigger frame, the transmitted data and the ACK/NACK signal, wherein the processor sets an ACK policy value of the STA to a specific value and controls the transceiver to receive the ACK/NACK signal for the transmitted data through an M-BA frame when the specific value is a first value and to transmit a block ACK request message to the AP and receive an ACK/NACK signal when the specific value is a fourth value.

### Advantageous Effects

According to the present invention, an AP can flexibly transmit acknowledgement/negative-acknowledgement signals to a plurality of STAs in a UL MU transmission situation.

### DESCRIPTION OF DRAWINGS

FIG. 1 is a diagram illustrating an exemplary configuration of a WLAN system.

FIG. 2 is a diagram illustrating another exemplary configuration of a WLAN system.

FIG. 3 is a diagram illustrating a block ACK mechanism used in a WLAN system.

FIG. 4 is a diagram illustrating a basic configuration of a block ACK frame.

FIG. 5 is a diagram illustrating a detailed configuration of a BA Control field in FIG. 4.

FIG. 6 is a diagram illustrating a detailed configuration of a BA Information field in FIG. 4.

FIG. 7 is a diagram illustrating a configuration of a Block ACK Start Sequence Control subfield.

FIG. 8 is a diagram illustrating a configuration of a BS Information field of a compressed Block ACK frame.

FIG. 9 is a diagram illustrating a BA Information field of a multi-TID Block ACK frame.

FIGS. 10 and 11 are diagrams for explaining the case in which a block ACK mechanism is applied to a DL MU-MIMO scheme.

FIG. 12 is a diagram for explaining a UL MU transmission situation to which the present invention is applicable.

FIG. 13 is a diagram illustrating a frame structure to be used for a DL MU block ACK mechanism according to an exemplary embodiment of the present invention.

FIG. 14 is a diagram illustrating a method of transmitting ACK/NACK signals to a plurality of STAs using an ACK policy according to an embodiment of the present invention.

FIG. 15 is a diagram illustrating a method of transmitting ACK/NACK signals to a plurality of STAs using an ACK policy according to another embodiment of the present invention.

FIG. 16 is a diagram illustrating a method of transmitting ACK/NACK signals to a plurality of STAs using an ACK policy according to another embodiment of the present invention.

FIGS. 17 and 18 are diagrams illustrating a method of allocating resources through an additional trigger frame in TXOP according to other embodiments of the present invention.

FIGS. 19 and 20 are diagrams illustrating operations when STAs set to an ACK policy value of 11 transmit a last UL MU frame according to other embodiments of the present invention.

FIG. 21 is a diagram illustrating an example in which an AP transmits ACK/NACK signals to all STAs through one M-BA frame according to another embodiment of the present invention.

FIGS. 22 and 23 are diagrams illustrating a case in which an AP explains an ACK policy value when a trigger frame is transmitted according to another embodiment.

FIG. 24 is a diagram illustrating a method of compressing an M-BA frame transmitted to an STA to which ACK/NACK needs to be transmitted based on a BAR according to one embodiment of the present invention.

FIG. 25 is a diagram illustrating a method of compressing an M-BA frame transmitted to an STA to which ACK/NACK needs to be transmitted based on a BAR according to another embodiment of the present invention.

FIG. 26 illustrates an example of a case in which an AP fails in reception of an MPDU among MPDUs of a specific STA in the embodiment described with reference to FIG. 25.

FIG. 27 is a diagram for explaining an apparatus for implementing a method according to the present invention.

### BEST MODE

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

The following detailed description includes specific details in order to provide a thorough understanding of the present invention. However, it will be apparent to those skilled in the art that the present invention may be practiced without such specific details. In some instances, known structures and devices are omitted or are shown in block diagram form, focusing on important features of the structures and devices, so as not to obscure the concept of the present invention.

As described above, the following description relates to a method for efficiently utilizing a channel having a wide bandwidth in a WLAN system and an apparatus therefor. To this end, a WLAN system to which the present invention is applicable will be described first in detail.

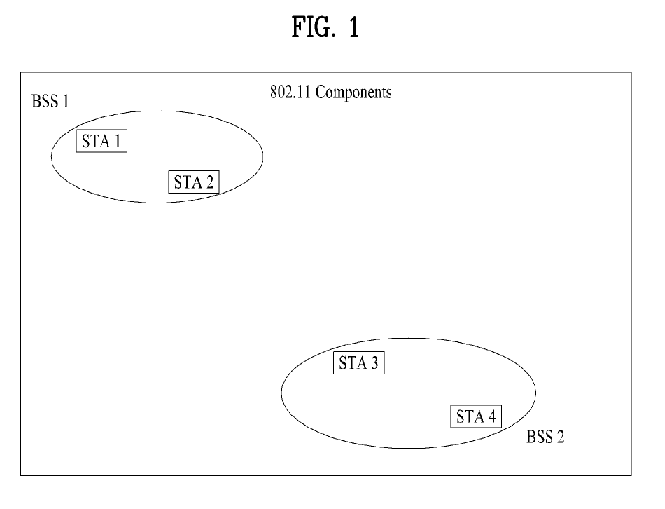

FIG. 1 is a diagram illustrating an exemplary configuration of a WLAN system.

As illustrated in FIG. 1, the WLAN system includes at least one Basic Service Set (BSS). The BSS is a set of STAs that are able to communicate with each other by successfully performing synchronization.

An STA is a logical entity including a physical layer interface between a Media Access Control (MAC) layer and a wireless medium. The STA may include an AP and a non-AP STA. Among STAs, a portable terminal manipulated by a user is the non-AP STA. If a terminal is simply called an STA, the STA refers to the non-AP STA. The non-AP STA may also be referred to as a terminal, a Wireless Transmit/Receive Unit (WTRU), a User Equipment (UE), a Mobile Station (MS), a mobile terminal, or a mobile subscriber unit.

The AP is an entity that provides access to a Distribution System (DS) to an associated STA through a wireless medium. The AP may also be referred to as a centralized controller, a Base Station (BS), a Node-B, a Base Transceiver System (BTS), or a site controller.

The BSS may be divided into an infrastructure BSS and an Independent BSS (IBSS).

The BSS illustrated in FIG. 1 is the IBSS. The IBSS refers to a BSS that does not include an AP. Since the IBSS does not include the AP, the IBSS is not allowed to access to the DS and thus forms a self-contained network.

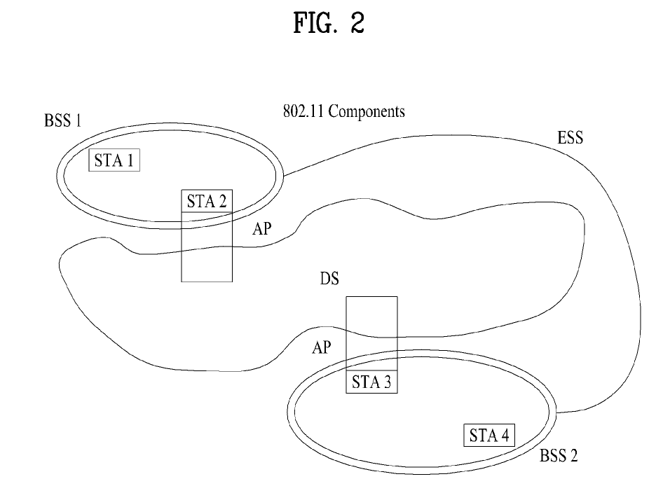

FIG. 2 is a diagram illustrating another exemplary configuration of a WLAN system.

BSSs illustrated in FIG. 2 are infrastructure BSSs. Each infrastructure BSS includes one or more STAs and one or more APs. In the infrastructure BSS, communication between non-AP STAs is basically conducted via an AP. However, if a direct link is established between the non-AP STAs, direct communication between the non-AP STAs may be performed.

As illustrated in FIG. 2, the multiple infrastructure BSSs may be interconnected via a DS. The BSSs interconnected via the DS are called an Extended Service Set (ESS). STAs included in the ESS may communicate with each other and a non-AP STA within the same ESS may move from one BSS to another BSS while seamlessly performing communication.

The DS is a mechanism that connects a plurality of APs to one another. The DS is not necessarily a network. As long as it provides a distribution service, the DS is not limited to any specific form. For example, the DS may be a wireless network such as a mesh network or may be a physical structure that connects APs to one another.

Based on the above description, a block ACK scheme in a WLAN system will be described hereinbelow.

A block ACK mechanism is a scheme of improving channel efficiency by aggregating and then transmitting a plurality of ACKs in one frame. There are two types of block ACK mechanism schemes: an immediate ACK scheme and a delayed ACK scheme. The immediate ACK scheme may be suitable for high-bandwidth, low-latency traffic transmission, whereas the delayed ACK scheme is favorable for applications that can tolerate latency. Unless particularly specified otherwise in the below description, an STA that transmits data using the block ACK mechanism is referred to as an originator and an STA that receives the data using the block ACK mechanism is referred to as a recipient.

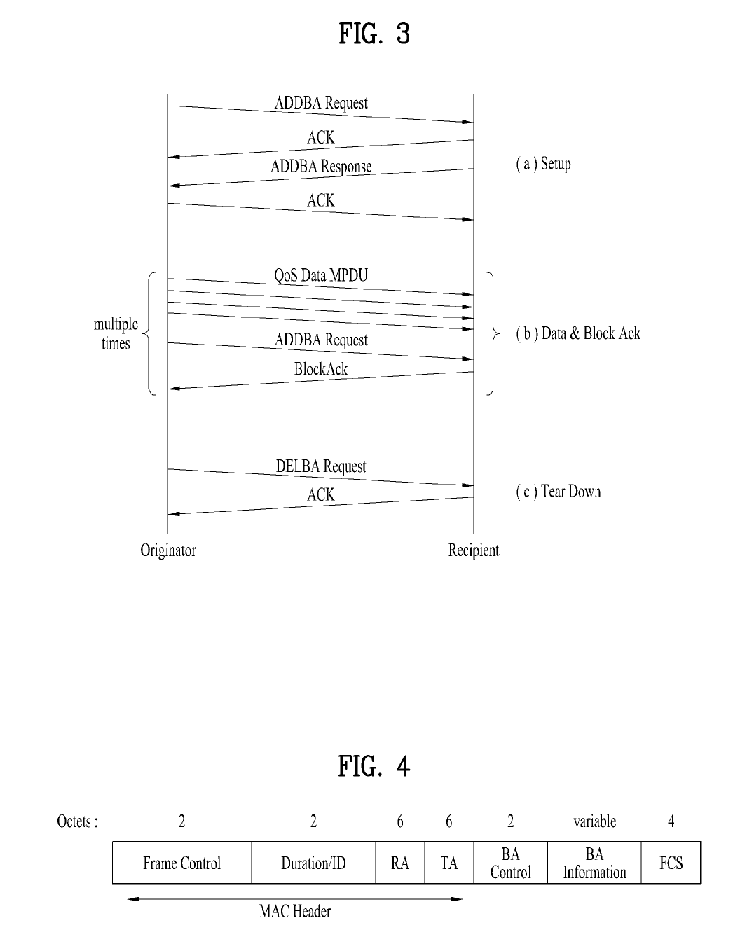

FIG. 3 is a diagram illustrating a block ACK mechanism used in a WLAN system.

The block ACK mechanism may be initialized by an exchange of Add Block Acknowledgment (ADDBA) request/response frames as illustrated in FIG. 3 ((a) Setup step). After the block ACK mechanism is initialized, a block of Quality of Service (QoS) data frames may be transmitted by an originator to a recipient. Such a block may be started within a polled Transmission Opportunity (TXOP) or by winning Enhanced Distributed Channel Access (EDCA) contention. The number of frames in the block may be limited. MAC Packet Data Units (MPDUs) in the block of frames may be acknowledged by a Block ACK frame, which is requested by a BlockAckReq frame ((b) Data & Block ACK step).

When the originator has no data to transmit and a final block ACK exchange is completed, the originator may end the block ACK mechanism by transmitting a Delete Block Acknowledgment (DELBA) frame to the recipient. Upon receiving the DELBA frame, the recipient may release all resources allocated for Block ACK transfer ((c) Tear Down step).

FIG. 4 is a diagram illustrating a basic configuration of a block ACK frame.

The block ACK frame may include a MAC Header field, a Block ACK (BA) Control field, and a BA Information field. The MAC Header field may include a Frame Control field, a Duration/ID field, an RA field, and a TA field. Herein, the RA field represents an address of a receiver STA and the TA field represents an address of a transmitter STA.

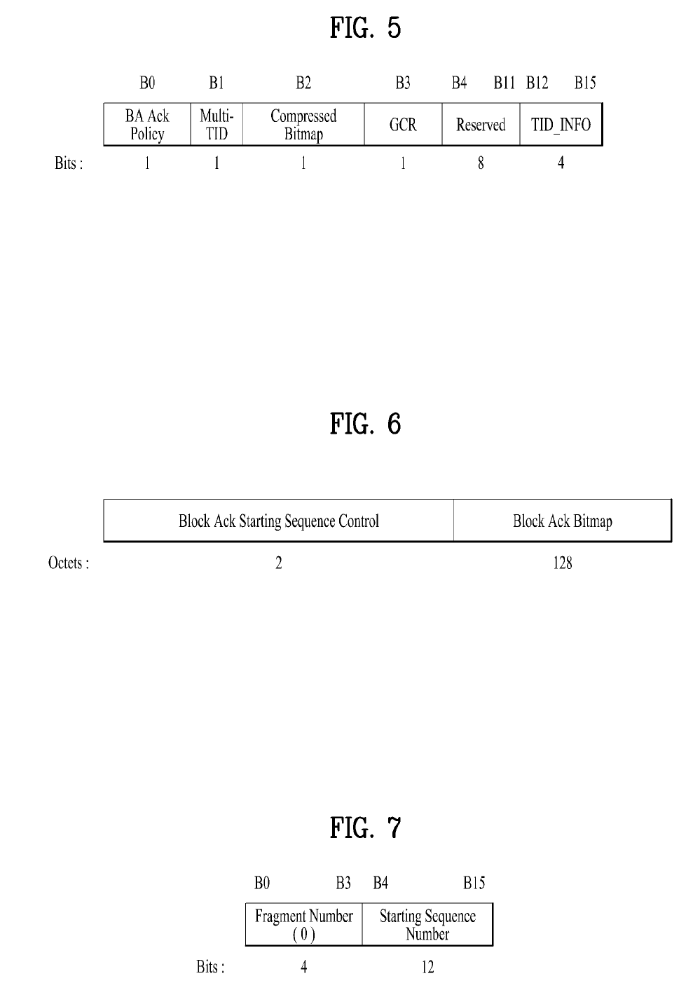

FIG. 5 is a diagram illustrating a detailed configuration of the BA Control field in FIG. 4.

A value of a BA ACK Policy subfield in the BA Control field may have the meaning shown in Table 1 below.

TABLE 1

| Value | Meaning |
|---|---|
| 0 | Normal Acknowledgment. |
| | The BA Ack Policy subfield is set to this value when the |
| | sender requires immediate acknowledgment. |
| | The addressee returns an Ack frame. |
| | The value 0 is not used for data sent under HT-delayed Block |
| | Ack during a PSMP sequence. |
| | The value 0 is not used in frames transmitted by DMG STAs. |
| 1 | No Acknowledgment. |
| | The addressee sends no immediate response upon receipt of |
| | the frame. |
| | The BA Ack Policy is set to this value when the sender does |
| | not require immediate acknowledgment. |
| | The value 1 is not used in a Basic BlockAck frame outside a |
| | PSMP sequence. |
| | The value 1 is not used in an Multi-TID BlockAck frame. |

Meanwhile, Multi-Traffic Identifier (TID), Compressed Bitmap, and GCR subfields in the BA Control field may determine possible Block ACK frame variants according to the following regulation.

TABLE 2

| Multi-TID | Compressed | GCR | |
|---|---|---|---|
| subfield | Bitmap | subfield | |
| value | subfield value | value | BlockAck frame variant |
| 0 | 0 | 0 | Basic BlockAck |
| 0 | 1 | 0 | Compressed BlockAck |
| 1 | 0 | 0 | Extended Compressed BlockAck |
| 1 | 1 | 0 | Multi-TID BlockAck |
| 0 | 0 | 1 | Reserved |
| 0 | 1 | 1 | GCR BlockAck |
| 1 | 0 | 1 | Reserved |
| 1 | 1 | 1 | Reserved |

FIG. 6 is a diagram illustrating a detailed configuration of the BA Information field in FIG. 4 and FIG. 7 is a diagram illustrating a configuration of a Block ACK Start Sequence Control subfield.

As illustrated in FIG. 6, the BA Information field may include a Block ACK Starting Sequence Control (SSC) subfield and a Block ACK Bitmap subfield.

As illustrated in FIG. 6, the Block ACK Bitmap subfield is 128 octets in length and thus may represent a reception status of 64 MAC Service Data Units (MSDUs). If a bit position n of the Block ACK Bitmap subfield is set to 1, this may indicate that an MPDU having an MPDU sequence control value corresponding to (SSC+n) has been successfully received, wherein SSC denotes a value of the Block ACK Starting Sequence Control subfield. In contrast, if the bit position n of the Block ACK Bitmap field is set to 0, this may indicate that the MPDU having the MPDU sequence control value corresponding to (SSC+n) has not been received. Each of values of an MPDU Sequence Control field and the Block ACK Starting Sequence Control subfield may be treated as a 16-bit unsigned integer. For unused fragment numbers of an MSDU, corresponding bits in a bitmap may be set to 0.

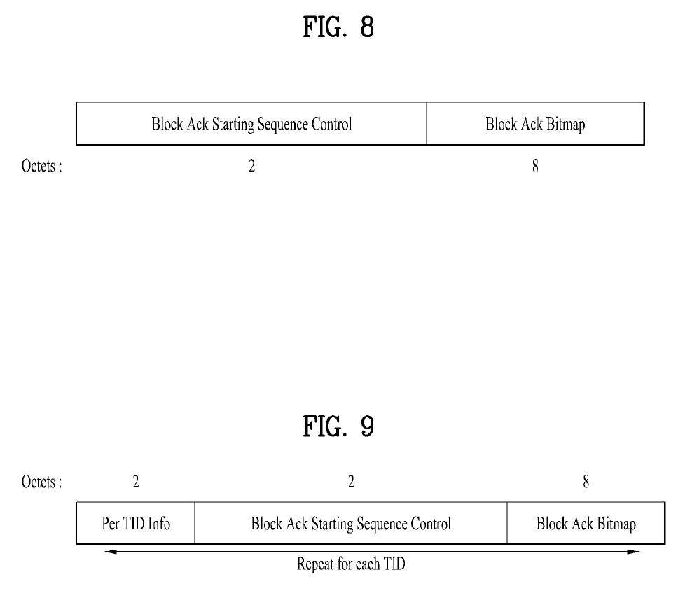

FIG. 8 is a diagram illustrating a configuration of a BS Information field of a compressed Block ACK frame.

As illustrated in FIG. 8, a Block ACK Bitmap subfield of the BS Information field of the compressed Block ACK frame may be 8 octets in length and indicate a reception status of 64 MSDUs and A-MSDUs. The first bit of a bitmap corresponds to an MSDU or an A-MSDU matching a value of a Block ACK Starting Sequence Control subfield and respective bits may sequentially correspond to MSDUs or A-MSDUs after the above MSDU or the A-MSDU.

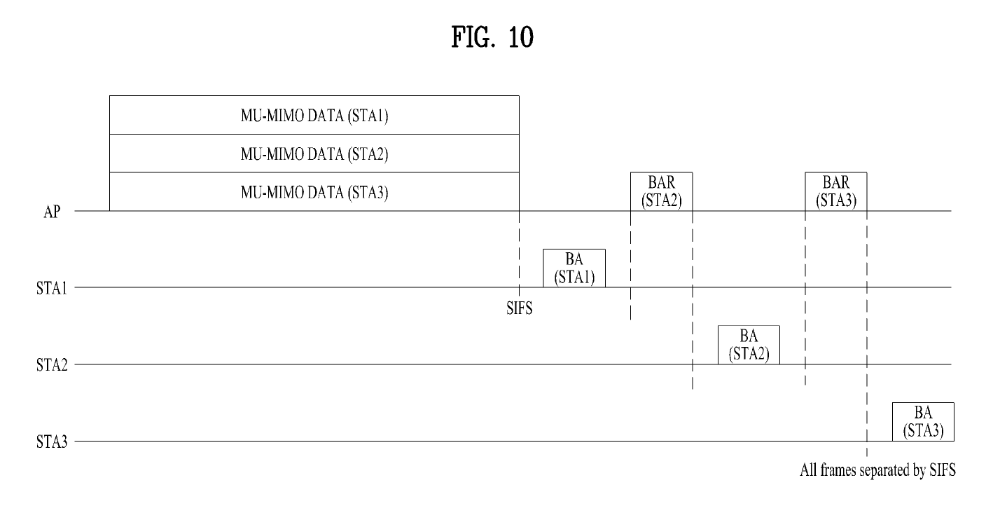

FIG. 9 is a diagram illustrating a BA Information field of a multi-TID Block ACK frame.

A TID_INFO subfield of the BA Information field of the multi-TID Block ACK frame contains information about the number of TIDs in the BA Information field. Specifically, a value of the TID_INFO subfield represents (the number of TIDs corresponding to information of the BA Information field)−1. For example, if the value of the TID_INFO subfield is 2, this may indicate that the BA Information field contains information about three TIDs.

Meanwhile, the multi-TID Block ACK frame may include a Per TID Info subfield in addition to a Block ACK Starting Sequence Control subfield and a Block ACK Bitmap subfield as illustrated in FIG. 9. The first emerging Per TID Info, Block ACK Starting Sequence Control, and Block ACK Bitmap subfields may be transmitted in correspondence to the lowest TID value and subsequently repeated subfields may correspond to the next TID. A triplet of these subfields may be repeated per TID.

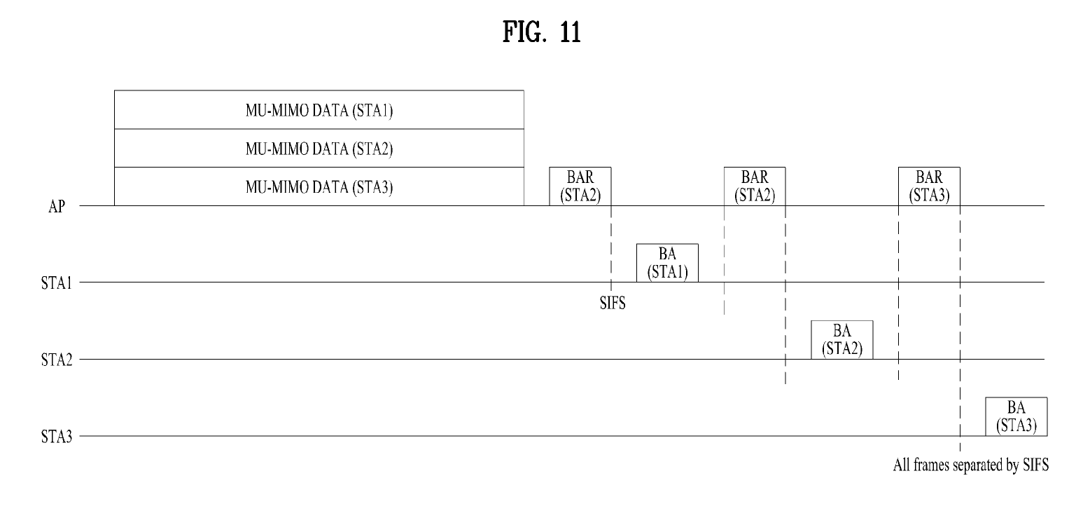

FIGS. 10 and 11 are diagrams for explaining the case in which a block ACK mechanism is applied to a DL MU-MIMO scheme.

As illustrated in FIGS. 10 and 11, an AP may transmit MU-MIMO data frames to a plurality of STAs STA 1 to STA 3.

It is assumed in FIG. 10 that frame exchange is performed after a Short InterFrame Space (SIFS) after an MU PLCP Packet Data Unit (PPDU) is transmitted. It is also assumed in FIG. 10 that for STA1, an implicit block ACK request is configured as ACK policy and, for STA 2 and STA 3, a block ACK is configured as ACK policy. Then, STA 1 may immediately transmit a BA frame after receiving a DL MU PPDU even without receiving a request for the block ACK. In contrast, the AP may perform polling by transmitting a BA request (BAR) frame to STA 2 and STA 3 and then STA 2 and STA 3 may transmit BA frames.

Meanwhile, FIG. 11 illustrates an example of performing a frame exchange without an SIFS after an MU PPDU is transmitted and it is assumed that a block ACK is configured as ACK policy for all STAs. Therefore, the AP may perform polling by transmitting a BAR frame to all STAs.

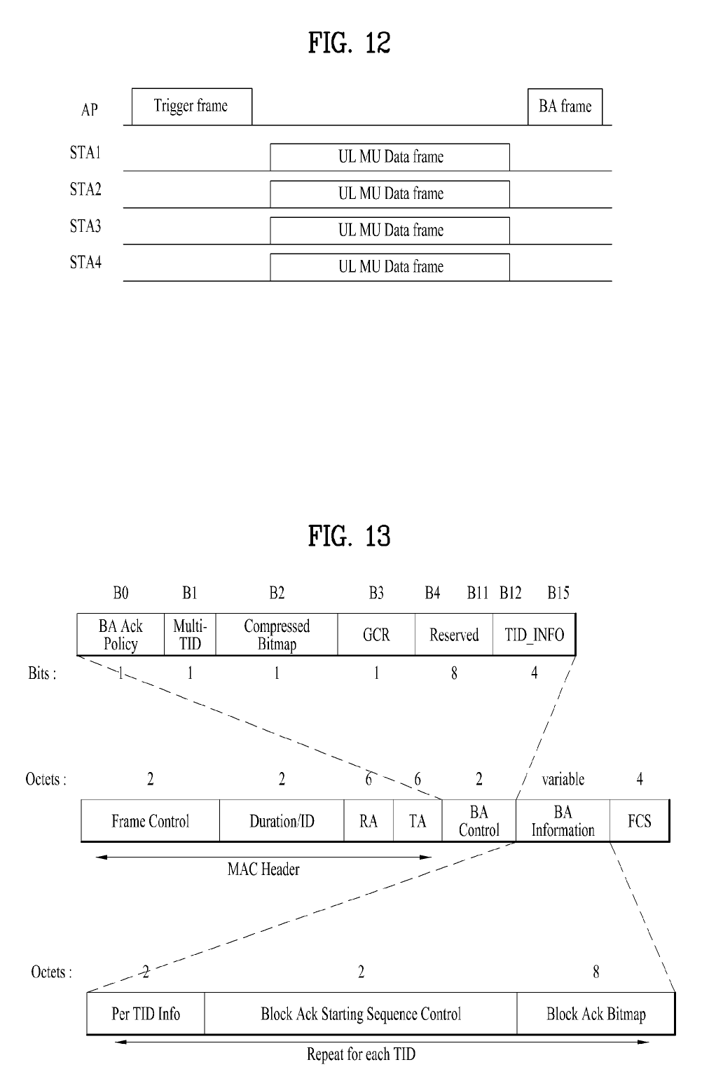

FIG. 12 is a diagram for explaining a UL MU transmission situation to which the present invention is applicable.

A UL MU transmission scheme may be used in an 802.11ax system as described above and may be initialized when an AP transmits a trigger frame to a plurality of STAs (e.g., STA 1 to STA 4) as illustrated in FIG. 12. The trigger frame may include UL MU allocation information (e.g. resource location and size, STA IDs, an MCS, and an MU type (MIMO, OFDMA, etc.)). Specific examples of information transmitted in the trigger frame may be as follows.

TABLE 3
Duration of a UL MU frame
Number of allocation (N)
Each allocation's Information
SU/MU
AID (for MU, as many AIDs as the number of STAs are additionally
included.)
Power adjustment
Tone(/Resource) allocation information (e.g., bitmap)
MCS
Nsts
STBC
Coding
Beamformed
Etc.

Meanwhile, as illustrated in FIG. 12, the AP may obtain a TXOP for transmitting the trigger frame via a contention procedure in order to access a medium. The STAs may transmit UL data frames with a format indicated by the AP after an SIFS of the trigger frame. It is assumed that the AP according to the present invention transmits an ACK of the UL MU data frames through a BA frame.

However, the above-described BA frame for the UL MU frames considerably increases in size as compared with a BA frame for a UL MU frame, thereby causing a serious overhead problem. For example, the BA frame transmitted by STA 1 in FIGS. 10 and 11 includes BA information about data transmitted by the AP to STA 1, whereas the BA frame transmitted by the AP in FIG. 12 includes BA information about the UL MU data frames transmitted by STA 1 to STA 4. In addition, since the size of a MAC frame corresponds to 32 bytes when a compressed Block ACK is used and 150 bytes when a normal block ACK is used, overhead may be problematic.

Accordingly, exemplary embodiments of the present invention propose a method for efficiently transmitting a BA frame by using a multi-TID block ACK frame format among the above-described BA frames.

FIG. 13 is a diagram illustrating a frame structure to be used for a DL MU block ACK mechanism according to an exemplary embodiment of the present invention.

A multi-STA BA frame or M-BA frame to be used according to an embodiment of the present invention may basically have a multi-TID BA frame as illustrated in FIG. 13 and may desirably include an indicator indicating that a corresponding BA frame is not a simple multi-TID BA frame but a multi-STA BA frame. Accordingly, a BA Information field may include BA information about different STAs as opposed to a conventional field.

In FIG. 13, in a BA control field, a multi-AID field indicates whether block ACK information including AID information is included in the BA information field, and block ACK information (block ACK starting sequence control and block ACK bitmap) may be included in each AID and transmitted.

In this case, when the number of STAs increases, block ACK frame overhead increases. For example, when there are 18 OFDMA STAs at 40 MHz, the block ACK frame has a size of 238 bytes and has overhead of about 85 symbols (340 μs) when transmission is performed with MCS 0.

To solve the aforementioned problem, the frame may be configured such that the frame optionally includes (1) a block ACK starting sequence control field and (2) a block ACK bitmap. For example, when an AP has successfully received data of all STAs, it is possible to use an indicator indicating that the data has been successfully received without including both the (1) block ACK starting sequence control field and (2) block ACK bitmap.

However, in a usual M-BA transmission situation, BA information (Per AID Info, Block ACK Starting Sequence Control and Block ACK Bitmap) is repeated by the number of AIDs and included in a BA frame and the size of the BA frame increases as the number of STAs increases. For example, when the BA frame is transmitted using PPDU frame format 11a and MCS 0 (BPSK ½ coding rate) and the number of STAs is 8, BA frame transmission time is 184 μs which exceeds EIFS time (e.g., 96 μs on the basis of 6 Mbps in 11a).

Here, an STA which is located in the same transmission area as a BA reception STA but is hidden from a BA transmission STA can attempt transmission after EIFS and thus BA transmission may not be successfully performed.

To solve the aforementioned problem, a method of flexibly transmitting an ACK/NACK signal on the basis of an ACK policy value per STA is proposed.

A QoS control field of a UL MU frame has the following configuration. Particularly, the QoS control field has a 2-bit field indicating an ACK policy at bits 5 and 6.

TABLE 4

| | | | | | | | | |
|---|---|---|---|---|---|---|---|---|
| Applicable frame | | | | | | | | |
| (sub) types | Bits 0-3 | Bit 4 | Bits 5-6 | Bit 7 | Bits 8 | Bit 9 | Bit 10 | Bits 11-15 |

| | | | | | |
|---|---|---|---|---|---|
| QoS CF-Poll and QoS CF- | TID | EOSP | Ack | Reserved | TXOP Limit |
| Ack + CF-Poll frames sent | | | Policy | | |
| by HC | | | | | |
| QoS Data + CF-Poll and | TID | EOSP | Ack | A-MSDU | TXOP Limit |
| QoS Data + CF-Ack + CF- | | | Policy | Present | |
| Poll frames sent by HC | | | | | |
| QoS Data and QoS | TID | EOSP | Ack | A-MSDU | AP PS Buffer State |
| Data + CF-Ack frames sent | | | Policy | Present | |
| by HC | | | | | |
| QoS Null frames sent by | TID | EOSP | Ack | Reserved | AP PS Buffer State |
| HC | | | Policy | | |
| QoS Data and QoS | TID | 0 | Ack | A-MSDU | TXOP Duration Requested |
| Data + CF-Ack frames sent | | | Policy | Present | |
| by non-AP STAs that are | TID | 1 | Ack | A-MSDU | Queue Size |
| not a TPU buffer STA or a | | | Policy | Present | |
| TPU sleep STA in a | | | | | |
| nonmesh BSS | | | | | |
| QoS Null frames sent by | TID | 0 | Ack | Reserved | TXOP Duration Requested |
| non-AP STAs that are not a | | | Policy | | |
| TPU buffer STA or a TPU | TID | 1 | Ack | Reserved | Queue Size |
| sleep STA in a nonmesh | | | Policy | | |
| BSS | | | | | |

TABLE 5

| Applicable frame | | | | | | | | |
|---|---|---|---|---|---|---|---|---|
| (sub) types | Bits 0-3 | Bit 4 | Bits 5-6 | Bit 7 | Bits 8 | Bit 9 | Bit 10 | Bits 11-15 |
| QoS Data and QoS | TID | EOSP | Ack | A-MSDU | Reserved | | | |
| Data + CF-Ack frames sent | | | Policy | Present | | | | |
| by TPU buffer STAs in a | | | | | | | | |
| nonmesh BSS | | | | | | | | |
| QoS Null frames sent by | TID | EOSP | Ack | Reserved | Reserved | | | |
| TPU buffer STAs in a | | | Policy | | | | | |
| nonmesh BSS | | | | | | | | |
| QoS Data and QoS | TID | Reserved | Ack | A-MSDU | Reserved | | | |
| Data + CF-Ack frames sent | | | Policy | Present | | | | |
| by TPU sleep STAs in a | | | | | | | | |
| nonmesh BSS | | | | | | | | |
| QoS Null frames sent by | TID | Reserved | Ack | Reserved | Reserved | | | |
| TPU sleep STAs in a | | | Policy | | | | | |
| nonmesh BSS | | | | | | | | |
| All frames sent by mesh | TID | EOSP | Ack | A-MSDU | Mesh | Mesh | RSPI | Reserved |
| STAs in a mesh BSS | | | Policy | Present | Control | Power | | |
| | | | | | Present | Save | | |
| | | | | | | Level | | |

Values of the ACK policy field shown in Tables 4 and 5 are set as follows.

TABLE 6
ACK Policy == 00
Normal ACK or Implicit Block ACK Request.
In a frame that is a non-A-MPDU frame or VHT single MPDU:
The addressed recipient returns an ACK or QoS +CF-ACK frame after
a short interframe space (SIFS) period, according to the procedures
defined in ACK procedure and HCCA transfer rules. A non-DMG STA
sets the ACK Policy subfield for individually addressed QoS Null
(no data) frames to this value.
Otherwise:
The addressed recipient returns a Block ACK frame, either individually
or as part of an A-MPDU starting an SIFS after the PPDU carrying the
frame, according to the procedures defined in Block ACK procedure,
Generation and transmission of Block ACK frames by an HT STA or
DMG STA, Operation of HT-delayed block ACK, Rules for RD
initiator, Rules for RD responder, and Explicit feedback beamforming.

TABLE 7
ACK Policy == 01
No ACK
The addressed recipient takes no action upon receipt of the frame.
The ACK Policy subfield is set to this value in all individually addressed
frames in which the sender does not require acknowledgment. The ACK
Policy subfield is also set to this value in all group addressed frames that
use the QoS frame format except with a TID for which a block ACK
agreement exists.
This value of the ACK Policy subfield is not used for QoS Data frames
with a TID for which a block ACK agreement exists.
The ACK Policy subfield for group addressed QoS Null (no data) frames
is set to this value.

TABLE 8
ACK Policy == 10
No explicit acknowledgment or PSMP ACK.
When bit 6 of the Frame Control field (see Type and Subtype fields) is
set to 1:
There may be a response frame to the frame that is received, but it is
neither the ACK frame nor any Data frame of subtype +CF-ACK.
The ACK Policy subfield for QoS CF-Poll and QoS CF-ACK+CF-Poll
Data frames is set to this value.
When bit 6 of the Frame Control field (see Type and Subtype fields) is
set to 0:
The acknowledgment for a frame indicating PSMP ACK when it appears
in a PSMP downlink transmission time (PSMP-DTT) is to be received
in a later PSMP uplink transmission time (PSMP-UTT).
The acknowledgment for a frame indicating PSMP ACK when it appears
in a PSMPUTT is to be received in a later PSMP-DTT.
NOTE—Bit 6 of the Frame Control field (see Type and Subtype fields)
indicates the absence of a data payload. When equal to 1, the QoS Data
frame contains no payload, and any response is generated in response to
a QoS CF-Poll or QoS CF-ACK+CF-Poll frame, but does not signify an
acknowledgment of data. When set to 0, the QoS Data frame contains a
payload, which is acknowledged as described in PSMP acknowledgment
rules.

TABLE 9
ACK Policy == 11
Block ACK
The addressed recipient takes no action upon receipt of the frame except
for recording the state. The recipient can expect a BlockAckReq frame in
the future to which it responds using the procedure described in Block
acknowledgment (block ACK).

That is, the aforementioned ACK policy field may indicate four different values using 2 bits of information and the values are defined as shown in Tables 6 to 9. In the following description, a method by which an AP transmits ACK/NACK signals to multiple STAs more flexibly is proposed. While ACK policy values used in the following description may have additional meanings which will be described below in addition to the meanings shown in Tables 6 to 9, it is assumed that the definitions of Tables 6 to 9 are used unless otherwise mentioned.

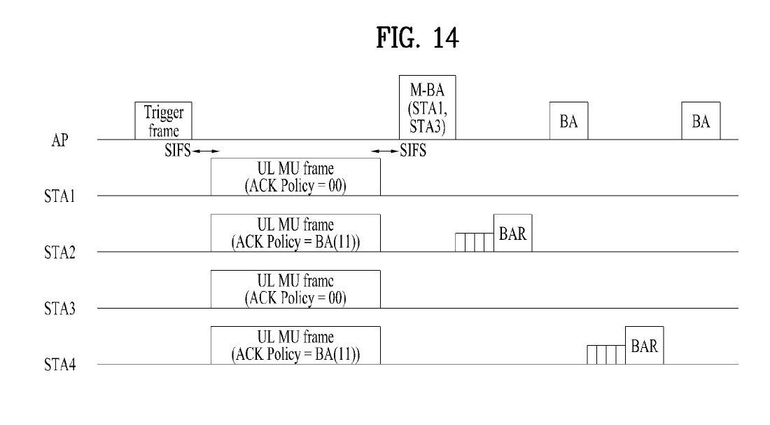

FIG. 14 is a diagram for illustrating a method of transmitting ACK/NACK signals to multiple STAs using an ACK policy according to an embodiment of the present invention.

As shown in the example of FIG. 14, an AP may transmit a trigger frame to STA 1 to STA 4 to cause them to transmit UL MU frames. Accordingly, STA 1 to STA 4 may include an ACK policy in MPDUs and transmit UL MU frames. In FIG. 14, it is assumed that STA 1 and STA 3 set an ACK policy value of 00 and STA 2 and STA 4 set an ACK policy value of 11.

When the ACK policy value of a UL MU frame is 00, the AP simultaneously transmits BA (i.e., transmits M-BA) to STAs which have transmitted UL MU frames indicating ACK policy==00 (implicit BA/ACK) immediately after an SIFS time after reception of the UL MU frames from the STAs on the assumption that implicit BA/ACK for a single MPDU is requested in the present embodiment. It is assumed that M-BA includes ACK/BA for multiple STAs. That is, when one or more UL MU frames having ACK policy==00 are received, the AP transmits M-BA after an SIFS. Then, the AP receives BARs from STAs which have transmitted UL MU frames in which the ACK policy is set to BA (11) and then transmits block ACK to the STAs which have transmitted the BARs.

In FIG. 14, the ACK policy of STA 1 and STA 3 is 00 (implicit BA or ACK for a single MPDU), and thus the AP simultaneously transmits BA/ACK to STA 1 and STA 3 after the SIFS after UL MU frame reception (i.e., transmits M-BA). Here, it is desirable that the AP transmit block ACK (multi-STA BA) including BA/ACK information about multiple STAs.

Thereafter, the AP may wait to receive BARs from STA 2 and STA 4 which have transmitted UL frames in which the ACK policy is set to BA (11). Then, STA 2 may transmit a BAR in a contention-based manner and the AP may transmit BA to STA 2 in response to the BAR. Subsequently, STA 4 may transmit a BAR in a contention-based manner and the AP may transmit BA to STA 4 in response to the BAR.

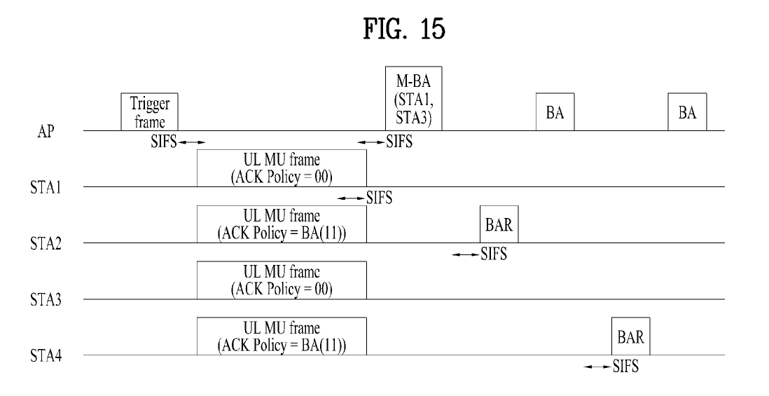

FIG. 15 is a diagram for illustrating a method of transmitting ACK/NACK signals to multiple STAs using the ACK policy according to another embodiment of the present invention.

The method of FIG. 15 differs from the method of FIG. 14 in that STAs having an ACK policy value set to 11 transmit BARs at a time predetermined on the basis of an SIFS instead of transmitting the BARs in a contention-based manner.

In another embodiment of the present invention, a method of indicating an ACK policy value in a trigger frame when MU resources for STAs are allocated and setting STAs such that they can recognize whether the ACK policy of STAs is BA or implicit BA/ACK is proposed. When there are multiple STAs which need to transmit a BAR (that is, when there are multiple STAs having an ACK policy corresponding to BA), a BAR transmission order may be determined in order of the STAs.

That is, the first allocated STA (e.g., STA 2 in FIGS. 14 and 15) among STAs may transmit a BAR after the SIFS after reception of M-BA. The second STA (STA 4 in FIGS. 14 and 15) may transmit a BAR after the SIFS after reception of BA for the first STA.

In the present embodiment, transmission of ACK policy information may be skipped. That is, an ACK policy value may be set per STA and an ACK policy value may be transmitted in a UL MU frame or a trigger frame only when existing ACK policy values are overridden.

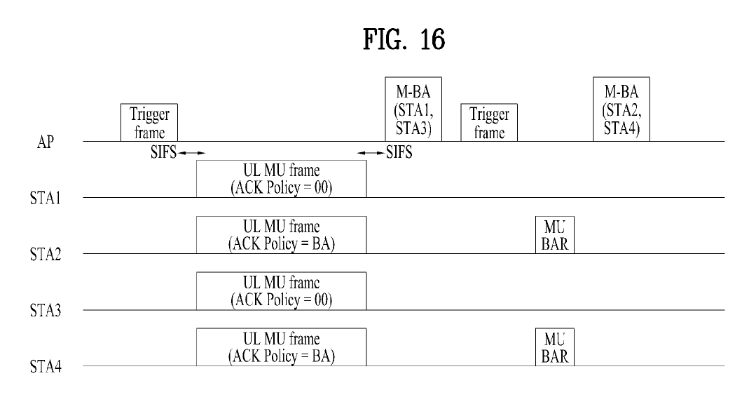

FIG. 16 is a diagram for illustrating a method of transmitting ACK/NACK signals to multiple STAs using the ACK policy according to another embodiment of the present invention.

The example of FIG. 16 differs from the cases of FIGS. 14 and 15 in that STAs having an ACK policy value corresponding to BA transmit BARs in the form of a multi-user frame.

Specifically, in the present embodiment, a UL STA may include an ACK policy in a UL MU frame and transmit the UL MU frame. When the ACK policy of the UL MU frame is 00 (implicit BA or ACK for a single MPDU), an AP may simultaneously transmit BA to STAs which have transmitted UL MU frames indicating implicit BA or ACK for a single MPDU immediately after the SIFS after UL MU frame reception (e.g., transmits through M-BA) and transmit a trigger frame to STAs having an ACK policy corresponding to BA to allocate MU resources thereto such that the STAs can transmit MU BARs. Here, M-BA and the trigger frame may be transmitted in a single frame (e.g., PHY frame or MAC frame).

When the AP simultaneously receives BARs from STAs having an ACK policy corresponding to MU BA, the AP may simultaneously transmit BA (e.g., M-BA) in response to the BARs.

In the example of FIG. 16, since the ACK policy of STA 1 and STA 3 is 00 (implicit BA/ACK), the AP can simultaneously transmit BA to STA 1 and STA 3 after SIFS after reception of UL MU frames. Here, the AP may transmit block ACK (e.g., M-BA) including BA information about multiple STAs. Thereafter, the AP may transmit a trigger frame after the SIFS or a specific time (e.g., EDCA based random backoff), for example, in order to receive MU BARs from STA 2 and STA 4. Here, a UL traffic type may be set to the BAR in the trigger frame. STA 2 and STA 4 may receive the trigger frame and transmit MU BARs and the AP may transmit M-BA to STA 2 and STA 4 in response to the BARs. Here, MU BA transmitted to STA 2 and STA 4 may have different formats.

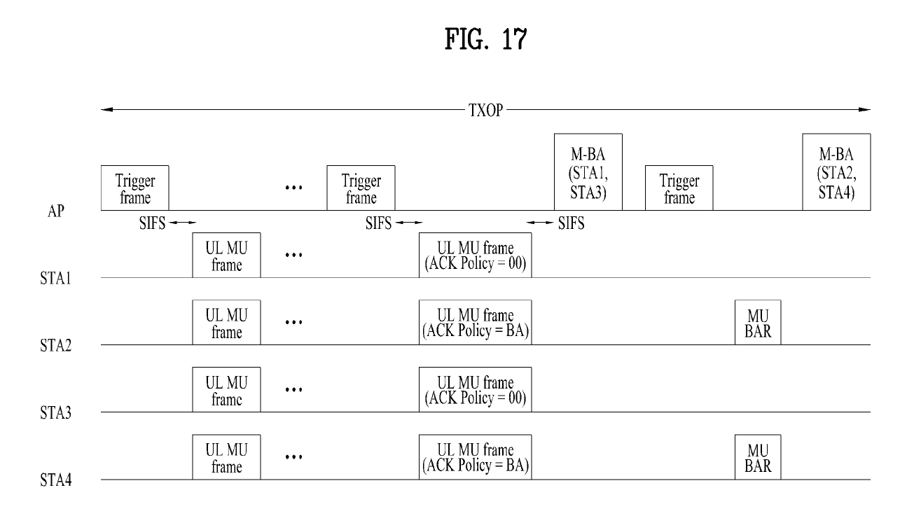

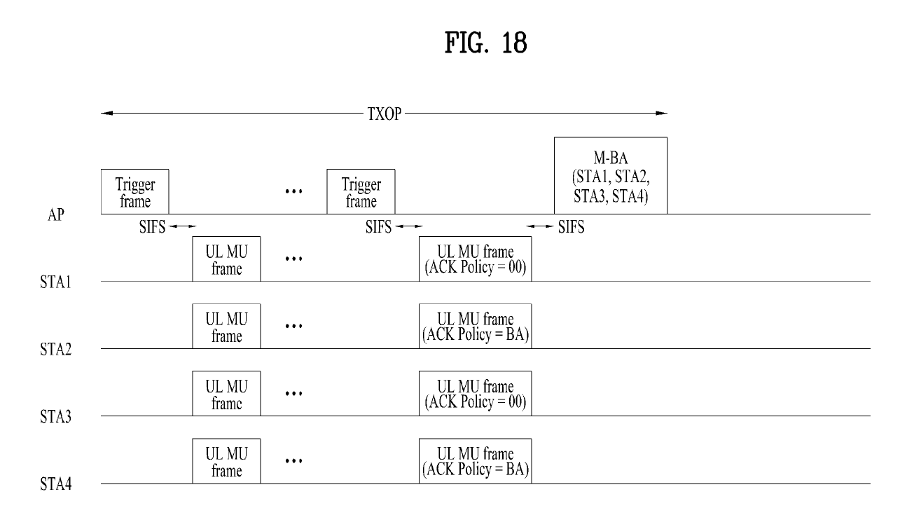

FIGS. 17 and 18 are diagrams for describing a method of allocating resources through an additional trigger frame in a TXOP according to other embodiments of the present invention.

In the above-described embodiments, the trigger frame, which is transmitted in order to allocate resources for UL MU BAR transmission, may be transmitted when the last UL MU frame transmission resource is allocated or may be transmitted once at the end of a TXOP.

Specifically, as shown in FIG. 17, an AP may allocate the last UL MU resource region through a trigger frame in the current TXOP. Thereafter, the AP may transmit M-BA for ACK policy==0 after SIFS upon reception of a UL MU frame, and transmit a trigger frame in order to receive MU BARs from STAs having ACK policy=1. In this example, MU BAR transmission resource allocation is performed after allocation of the last UL MU frame resources, but the AP may perform resource allocation for MU BAR transmission in the middle of the TXOP. In addition, although MU BAR resources can be allocated to a frequency resource position such as a UL MU frame, they may be allocated to other resource positions through a trigger frame.

When an M-BA frame for the last UL MU frame is transmitted, BA information about ACK policy==11 may be included in the M-BA frame and transmitted without reception of a BAR, which is shown in FIG. 18.

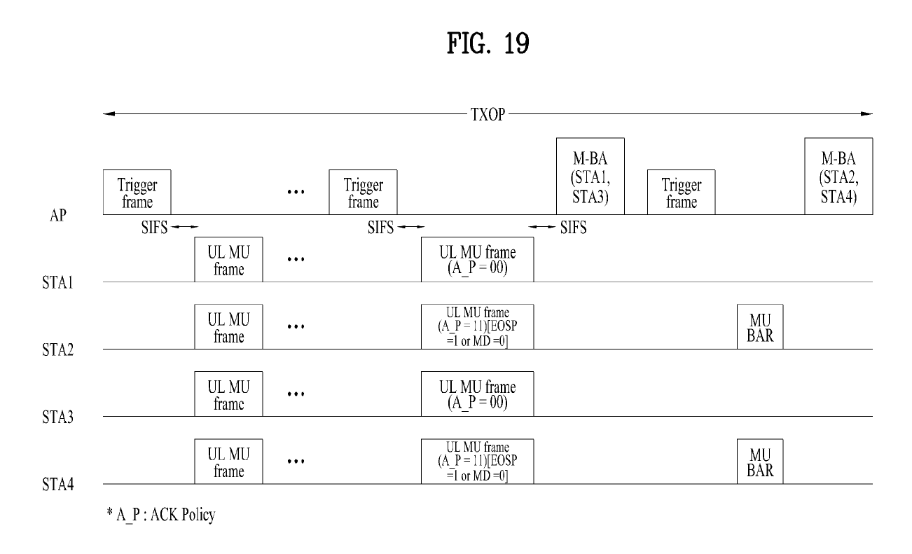

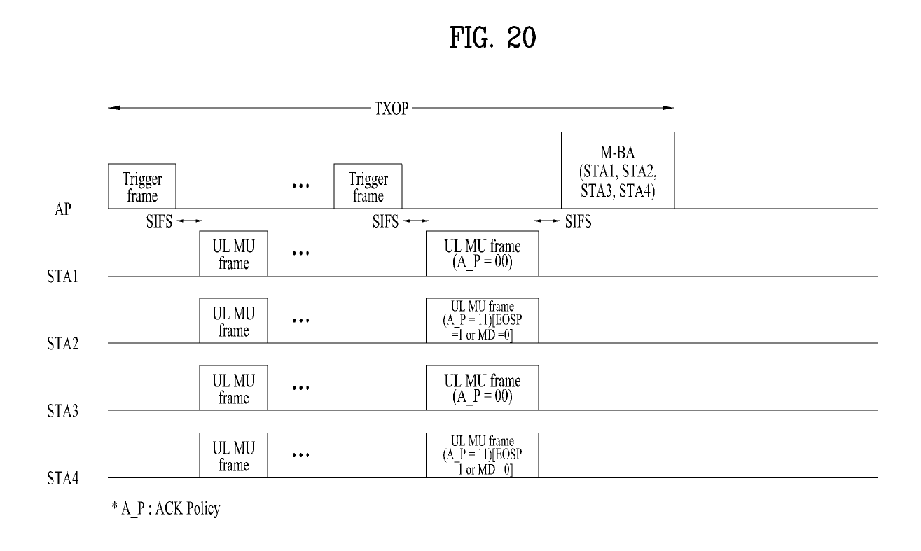

FIGS. 19 and 20 are diagrams for describing operations of STAs having an ACK policy value set to 11 when the STAs transmit last UL MU frames according to other embodiments of the present invention.

Specifically, in the example of FIG. 19, when last UL MU frames (e.g., EOSP=1 or MD=0) are received from STAs which transmit UL MU frames in which an ACK policy value is set to 11, an AP may transmit a trigger frame to the STAs in order to allocate UL MU resources for MU BAR transmission.

In FIG. 20, when last UL MU frames (e.g., EOSP=1 or MD=0) are received from STAs which transmit UL MU frames in which an ACK policy value is set to 11, the AP may include BA information about ACK policy==11 in M-BA and transmit the M-BA without BAR reception.

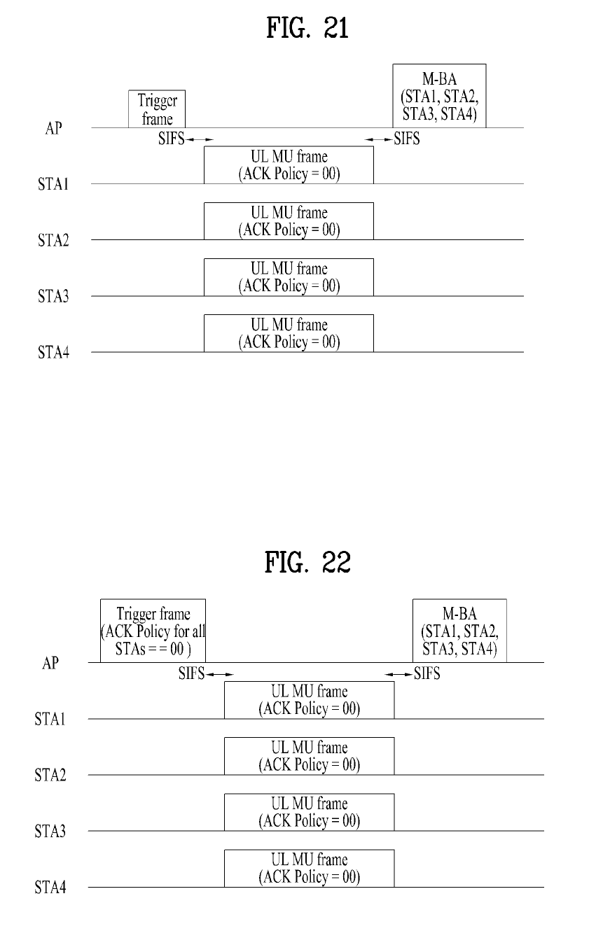

FIG. 21 is a diagram illustrating an example in which an AP transmits ACK/NACK signals to all STAs through a single M-BA frame according to another embodiment of the present invention.

As shown in FIG. 21, in UL MU frame transmission, implicit BA may be used all the time and ACK/BA for all STAs may be included in M-BA for UL MU frames when the M-BA is transmitted.

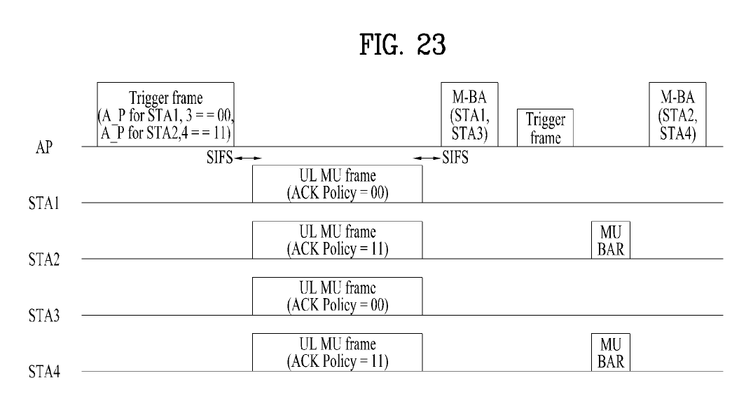

FIGS. 22 and 23 illustrate cases in which an AP describes an ACK policy value when the AP transmits a trigger frame according to another embodiment of the present invention.

Here, the AP may set an identical ACK policy or different ACK policies for all STAs in a trigger frame. FIG. 22 illustrates an example in which the same ACK policy==0 (implicit BA) is set for all STAs and FIG. 23 illustrates an example in which an ACK policy is set per STA.

In the example of FIG. 23, ACK policy A_P for STA 1 and STA 3 is set to 00 (implicit BA/ACK for a single MPDU) and ACK policy for STA 2 and STA 4 is set to 11 (block ACK). Accordingly, the AP may receive UL MU frames, transmit BA/ACK for STA 1 and STA 3 through M-BA and then allocate resources for MU BAR transmission of STA 2 and STA 4 through a trigger frame. As described above, upon reception of BARs (e.g., MU BARs) from multiple STAs, the AP may reply to the STAs by transmitting M-BA including BA information about the multiple STAs in a single frame. In this case, an M-BA format may be compressed and transmitted as necessary. A description will be given of embodiments of compressing an M-BA frame to reduce overhead.

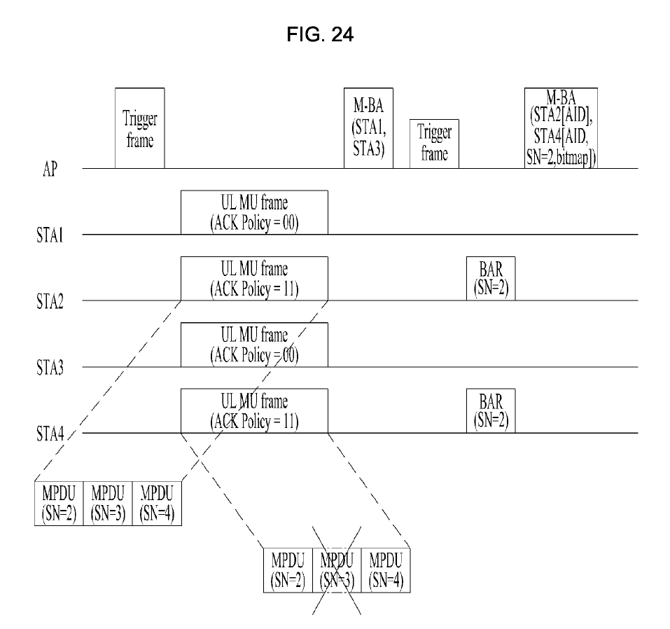

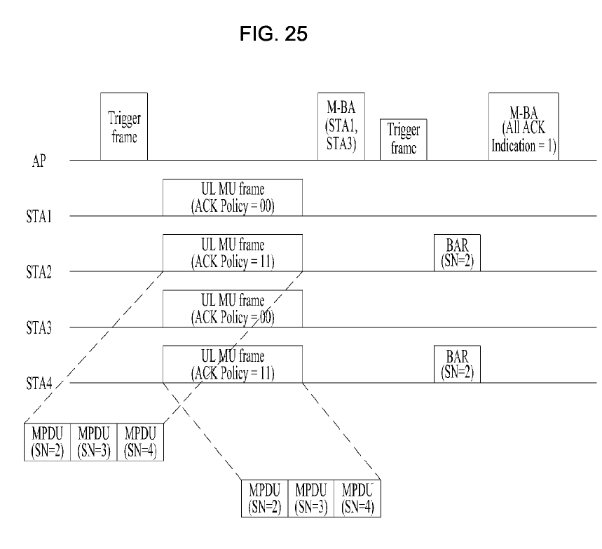

FIG. 24 is a diagram for describing a method of compressing an M-BA frame transmitted to an STA to which ACK/NACK needs to be transmitted on the basis of a BAR according to an embodiment of the present invention.

When a frame corresponding to a starting sequence number, which is indicated by a BAR transmitted from an STA, and all the following frames (SSN+window size) have been successfully received, the AP may simply indicate successful reception. For example, the AP may include the AID (or optionally TID) of the STA in BA information and may not include the BA Starting Sequence Control field and the BA Bitmap field therein. When the STA transmits a BAR and receives an M-BA frame in response to the BAR, the STA can determine that the receiver (AP) has successfully received an MPDU corresponding to an SSN indicated by the BAR and all the following MPDUs if the M-BA frame does not include BA SSC and BA Bitmap for the STA.

In the example of FIG. 24, ACK policies of STA 2 and STA 4 are set to BA (11), and thus the AP allocates MU resources through a trigger frame in order to receive BARs from the STAs. STA 2 and STA 4 may transmit BARs using the resources allocated through the trigger frame and the AP may transmit M-BA frames in response to the BARs. Here, since the AP has received the MPDU corresponding to SN=2 indicated by the BAR from STA 2 and all the following frames with respect to STA 2, the AP may include information (e.g., AID) other than the SSC and Bitmap in BA information about STA 2 and transmit the BA information. With respect to STA 4, the AP has not successfully received the MPDU corresponding to SN(=2) indicated by the BAR from STA 4 and all the following MPDU (error being generated in reception of the MPDU corresponding to SN=3), and thus may include the AID, SSC and bitmap in M-BA and transmit BA information about STA 4.

FIG. 25 is a diagram for describing a method of compressing an M-BA frame transmitted to an STA to which ACK/NACK needs to be transmitted on the basis of a BAR according to another embodiment of the present invention.

When the AP receives BARs from multiple STAs, if the AP successfully receives MPDUs corresponding to sequence numbers indicated by BARs transmitted from STAs and all the following MPDUs, the AP may simply indicate successful reception. For example, 1 bit (All ACK Indication) of a BA control field which is a field of the M-BA frame can indicate the successful reception. When this field is set to 1, BA information may not be included in the M-BA frame. When an STA receives an M-BA frame upon transmission of a BAR and the M-BA frame does not include BA information (e.g., All ACK Indication=1), the STA can determine that the receiver (AP) has successfully received the MPDU indicated by the starting sequence number indicated by the BAR and all the following frames from among MPDUs transmitted by the STA.

In the example of FIG. 25, the AP has received frames corresponding to SN(=2) indicated by BARs transmitted from STA 2 and STA 4 and all the following frames from among frames transmitted from STA 2 and STA 4 which has transmitted BARs, and thus the AP sets All ACK Indication to 1 and transmits the same. Since STA 2 and STA 4 receive M-BA frames having All ACK Indication=1 after transmission of the BARs, STA 2 and STA 4 determine that the receiver (AP) has received the frames corresponding to SN and all the following frames.

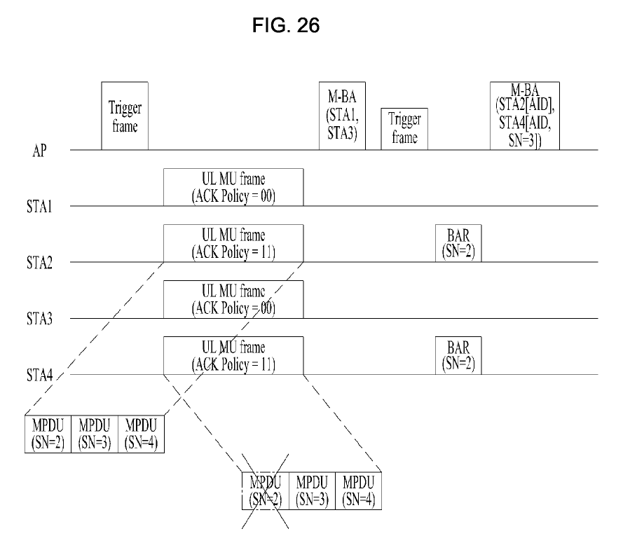

FIG. 26 illustrates an example of a case in which an AP fails in reception of an MPDU from among MPDUs of a specific STA in the embodiment described with reference to FIG. 25.

When the AP receives an MPDU corresponding to a specific SN and the following MPDUs from among the MPDU corresponding to an SN indicated by a BAR from an STA and the following MPDUs, the AP may include only the SSC (Starting Sequence Control) field without the bitmap field in BA information and transmit the BA information. That is, FIG. 26 shows an example of a case in which only SSC is included in BA information for a specific STA.

In the example of FIG. 26, the AP successfully receives only MPDUs corresponding to SN=3 and 4 from among MPDUs with respect to STA 4 although a BAR from STA 4 indicates SN=2. Accordingly, the AP can include only the BA Starting Sequence Control field having SN=3 in BA information about STA 4 and transmit the BA information.

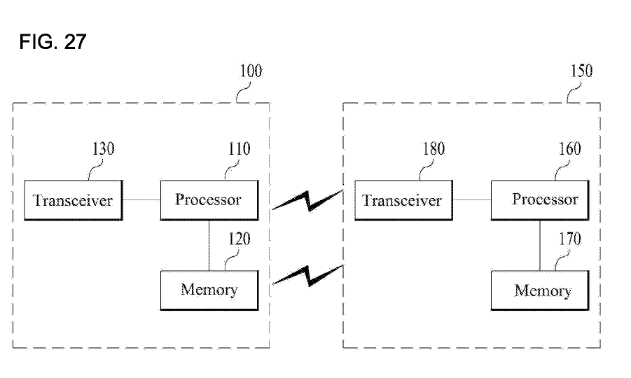

FIG. 27 is a diagram for explaining an apparatus for implementing the above-described method.

A wireless apparatus 800 of FIG. 27 may correspond to the above-described STA and a wireless apparatus 850 of FIG. 27 may correspond to the above-described AP.

The STA 800 may include a processor 810, a memory 820, and a transceiver 830 and the AP 850 may include a processor 860, a memory 870, and a transceiver 860. The transceivers 830 and 880 may transmit/receive a wireless signal and may be implemented in a physical layer of IEEE 802.11/3GPP. The processors 810 and 860 are implemented in a physical layer and/or a MAC layer and are connected to the transceivers 830 and 880. The processors 810 and 860 may perform the above-described UL MU scheduling procedure.

The processors 810 and 860 and/or the transceivers 830 and 880 may include an Application-Specific Integrated Circuit (ASIC), a chipset, a logical circuit, and/or a data processor. The memories 820 and 870 may include a Read-Only Memory (ROM), a Random Access Memory (RAM), a flash memory, a memory card, a storage medium, and/or a storage unit. If an embodiment is performed by software, the above-described method may be executed in the form of a module (e.g., a process or a function) performing the above-described function. The module may be stored in the memories 820 and 870 and executed by the processors 810 and 860. The memories 820 and 870 may be located at the interior or exterior of the processors 810 and 860 and may be connected to the processors 810 and 860 via known means.

The detailed description of the preferred embodiments of the present invention has been given to enable those skilled in the art to implement and practice the invention. Although the invention has been described with reference to the preferred embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

While the various embodiments of the present invention have been described in the context of an IEEE 802.11 based WLAN system, the present invention is not applied thereto. The present invention is identically applicable to various WLAN systems in which an AP can perform a block Ack mechanism for a plurality of STAs.

1. A method by which an access point (AP) transmits acknowledgement/negative-acknowledgement (ACK/NACK) signals for data transmitted from a plurality of stations (STAs) in a wireless LAN (WLAN) system, comprising:
transmitting a trigger frame to the plurality of STAs;
receiving data from the plurality of STAs in response to the trigger frame, at least one STA among the plurality of STAs having an ACK policy value set to a specific value; and
transmitting ACK/NACK signals for the data received from the plurality of STAs,
wherein ACK/NACK signals for STAs other than the at least one STA among the plurality of STAs are transmitted through a multi-user block ACK (M-BA) frame, and an ACK/NACK signal for the at least one STA is transmitted in response to a block ACK request message received from the at least one STA.

2. The method according to claim 1, wherein the ACK/NACK signal for the at least one STA is transmitted when the block ACK request message transmitted in a contention-based method from the at least one STA is received after the M-BA frame is transmitted.

3. The method according to claim 1, wherein the ACK/NACK signal for the at least one STA is transmitted when the block ACK request message transmitted from the at least one STA on the basis of an SIFS is received after the M-BA frame is transmitted.

4. The method according to claim 1, wherein the ACK policy value set to the specific value for the at least one STA is set through data received from the at least one STA.

5. The method according to claim 1, wherein the ACK policy value set to the specific value for the at least one STA is set by the AP and transmitted to the at least one STA through the trigger frame.

6. The method according to claim 1, wherein an additional trigger frame is transmitted to the at least one STA such that the at least one STA transmits a multi-user block ACK request message.

7. The method according to claim 6, wherein, when the multi-user block ACK request message is received, the ACK/NACK signal for the at least one STA is transmitted through an additional M-BA frame.

8. The method according to claim 7, wherein the additional M-BA frame does not include start sequence information and a block ACK bitmap when all data units are successfully received from the at least one STA.

9. The method according to claim 7, wherein, when a specific data unit and the following data units from among data received from the at least one STA are successfully received, the additional M-BA frame includes start sequence information corresponding to the specific data unit without a block ACK bitmap.

10. The method according to claim 1, wherein the ACK policy value is set to one of a first value indicating an implicit block ACK request, a second value for requesting no ACK/NACK for transmitted data, a third value for requesting only an ACK/NACK signal of a specific mode and a fourth value for requesting block ACK request message based ACK/NACK signal transmission.

11. The method according to claim 10, wherein the ACK policy value set to the specific value has the fourth value.

12. The method according to claim 10, wherein STAs other than the at least one STA from among the plurality of STAs have ACK policy values set to the first value.

13. A method by which an STA receives an ACK/NACK signal for transmitted data from an AP in a WLAN system, comprising:
receiving a trigger frame from the AP;
transmitting data to the AP through a multi-user frame in response to the trigger frame, an ACK policy value for the STA being set to a specific value;
receiving the ACK/NACK signal for the transmitted data through an M-BA frame when the specific value is a first value; and
transmitting a block ACK request message to the AP and receiving an ACK/NACK signal when the specific value is a fourth value.

14. An AP apparatus for transmitting ACK/NACK signals for data transmitted from a plurality of STAs in a WLAN system, comprising:
a transceiver configured to transmit a trigger frame to the plurality of STAs, to receive data from the plurality of STAs in response to the trigger frame and to transmit ACK/NACK signals for the data received from the plurality of STAs; and
a processor connected to the transceiver and configured to process the trigger frame, the received data and the ACK/NACK signals,
wherein the processor controls the transceiver to transmit ACK/NACK signals for STAs other than at least one STA having an ACK policy value set to a specific value from among the plurality of STAs through an M-BA frame and to transmit an ACK/NACK signal for the at least one STA in response to a block ACK request message received from the at least one STA.

15. A station apparatus operating as an STA for receiving an ACK/NACK signal for transmitted data from an AP in a WLAN system, comprising:
a transceiver configured to receive a trigger frame transmitted to a plurality of STAs including the STA, to transmit data to the AP in response to the trigger frame and to receive an ACK/NACK signal for the data from the AP; and
a processor connected to the transceiver and configured to process the trigger frame, the transmitted data and the ACK/NACK signal,
wherein the processor sets an ACK policy value of the STA to a specific value and controls the transceiver to receive the ACK/NACK signal for the transmitted data through an M-BA frame when the specific value is a first value and to transmit a block ACK request message to the AP and receive an ACK/NACK signal when the specific value is a fourth value.
